(19) United States
(12) Patent Application Publication
(10) Pub. No.: US 2015/0300147 A1
(43) Pub. Date: Oct. 22, 2015

(54) APPARATUS AND PROCESS FOR CONVEYING AND RECOVERING HYDROCARBONS FROM AN UNDERWATER WELL OR FROM AN UNDERWATER PIPELINE IN UNCONTROLLED RELEASE (BLOWOUT) CONDITIONS

(71) Applicants: ENI S.P.A., Roma (IT); TEA SISTEMI S.P.A., Pisa (IT)

(72) Inventors: Giambattista DE GHETTO, San Donato Milanese (MI) (IT); Paolo ANDREUSSI, Pisa (IT)

(73) Assignees: ENI S.P.A., Roma (IT); TEA SISTEMI S.P.A., Pisa (IT)

(21) Appl. No.: 14/435,865

(22) PCT Filed: Oct. 11, 2013
(86) PCT No.: PCT/IB2013/059298

§ 371 Date: Apr. 15, 2015

(30) Foreign Application Priority Data
Oct. 16, 2012 (IT) MI2012A 001747

(51) Int. Cl. E21B 43/36; E21B 43/01; B01D 17/02

(52) U.S. Cl. CPC E21B 43/36; B01D 17/0214; E21B 43/01

(57) ABSTRACT

Apparatus and process for recovering hydrocarbons from an underwater well or pipeline in uncontrolled release conditions, wherein the apparatus comprises a separation chamber (11) having an inlet (11a) for a multi-phase stream comprising the flow of hydrocarbons (23) in outlet from the underwater well or from the underwater pipeline, and a plurality of outlets (13, 14, 18) for respectively conveying a mainly gas phase (21), a mainly light liquid phase (22b) and a mainly heavy liquid phase (22a) coming from the separation of the multi-phase stream in inlet, the inlet (11a) consisting of a directioning body (31) of the multi-phase stream towards the inside with respect to the separation chamber (11), the directioning body (31) comprising a first inlet end (31c) of the multi-phase stream and a second end (31b), opposite to the first end (31c), the second end (31b) being in fluid communication with the separation chamber (11) and it is characterised in that an outlet (18) for the mainly heavy liquid phase (22a) of the plurality of outlets (13,14,18) is in fluid connection with the inlet (11a) of the separation chamber (11).

The present invention refers to an apparatus and to a process for conveying and recovering hydrocarbons from an underwater well or from an underwater pipeline for extracting hydrocarbons in uncontrolled release conditions.

The constant increase in the global demand for hydrocarbon fluids has led to a growing activity in offshore exploration and production.

The submarine environment, in addition to making the production more difficult, leads to a greater risk of environment damage in the case in which there are blowouts i.e. an uncontrolled release of hydrocarbons from the extraction wells, and/or other uncontrolled leaking of hydrocarbons into the sea, for example, as a consequence of broken underwater pipelines.

Such events, although rare, are not only a loss in terms of energy, but can have very serious consequences in terms of safety of the workers, of pollution of the environment and of well recovering costs.

There have been many attempts in the past to try to ensure an effective recovery of the uncontrolled outflow of hydrocarbons in deep seas.

Blowout prevention systems known today have application limitations due to the formation of hydrates, especially at great sea depths and/or at high pressure conditions and low temperatures.

Indeed, at such depths, cold water, mixing with methane, leads to the formation of hydrates that tend to cause the separation system and/or hydrocarbon conveying lines to become blocked.

One solution for controlling underwater blowout is described in patent application n. WO2011/158093 the object of which is a conveying apparatus essentially consisting of a hollow cylindrical body provided with an inner quasi-cylindrical body, such as to identify inside it a separation chamber with an annular section in which the separation and stratification of the multiphase fluid in inlet occurs, in a light phase mainly made up of a gas and a heavy mainly liquid phase.

Such an apparatus is positioned above the exit of the well in blowout in a way such as to capture the flow of hydrocarbons in outlet, also called plume, so as to separate the gas part from the liquid part and subsequently convey them to the surface.

The apparatus object of patent application n. WO2011/158093 however, has the limitation of bringing, together with the jet, of hydrocarbons, significant amounts of sea water with flow rates also equal to many times that of liquid and gas hydrocarbons.

This phenomenon in addition to requiring pumping means that are over-sized with respect to those actually necessary for conveying only jets of liquid hydrocarbons, also leads to a considerable volume of fluids to be separated at the surface.

Moreover, in order to prevent hydrates from forming, methanol is required to be continuously introduced inside the apparatus from the surface, wherein the flow rate of methanol to be introduced is proportional to the flow rate of water to be treated.

The problems found above relating to the apparatus object of patent application n. WO2011/158093 can be partially solved by separating the water before the hydrocarbons are conveyed to the surface. However, the separation of two liquid phases at the bottom of the sea requires there to be very high separation volumes, making it difficult to manage the apparatus.

The purpose of the present invention is that of avoiding the drawbacks mentioned above and in particular that of making an apparatus and a process for conveying and recovering hydrocarbons from an underwater well or from an underwater pipeline in uncontrolled release conditions that are indeed capable of preventing the separation system and/or the hydrocarbon conveying lines from becoming blocked.

Another purpose of the present invention is that of providing an apparatus and a process for conveying and recovering hydrocarbons from an underwater well or from an underwater pipeline in uncontrolled release conditions that are capable of minimising the amount of sea water brought along with the jet of hydrocarbons.

A further purpose of the present invention is that of making an apparatus and a process for conveying and recovering hydrocarbons from an underwater well or from an underwater pipeline in uncontrolled release conditions that are capable of keeping the volumes of fluids to be separated low.

These and other purposes according to the present invention are achieved by making an apparatus for conveying and recovering hydrocarbons from an underwater well or from an underwater pipeline in uncontrolled release conditions as outlined in claim 1.

Such purposes are moreover achieved with a process for conveying and recovering hydrocarbons from an underwater well or from an underwater pipeline in uncontrolled release conditions according to claim 16.

Further characteristics of the apparatus and of the process for conveying and recovering hydrocarbons from an underwater well or from an underwater pipeline in uncontrolled release conditions are object of the dependent claims.

The characteristics and the advantages of an apparatus and of a process for conveying and recovering hydrocarbons from an underwater well or from an, underwater pipeline in uncontrolled release conditions according to the present invention shall become clearer from the following description, given as an example and not for limiting purposes, with reference to the attached schematic drawings, in which:

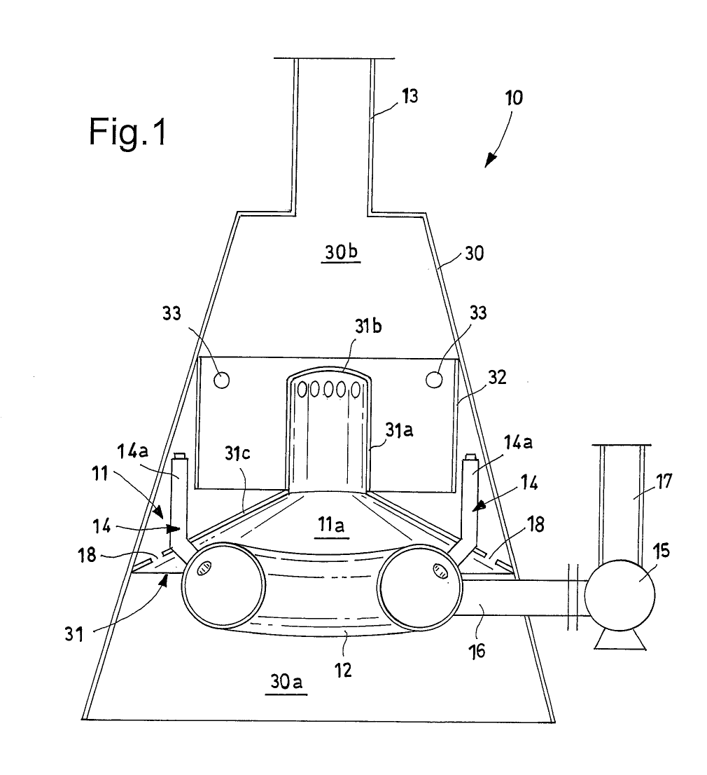

FIG. 1 is a schematic section view of an apparatus for conveying and recovering hydrocarbons from an underwater well in uncontrolled release conditions according to a preferred embodiment of the present invention;

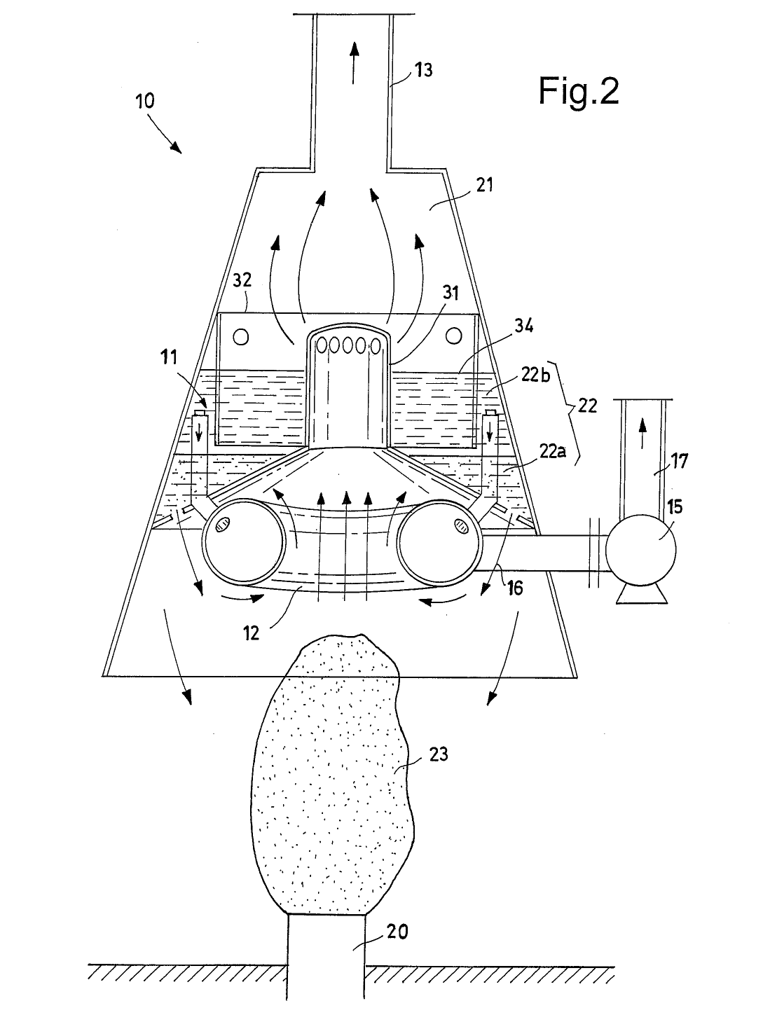

FIG. 2 is a qualitative scheme of the flows of mass inside the apparatus for conveying and recovering hydrocarbons of FIG. 1.

With reference to the figures, an apparatus for conveying and recovering hydrocarbons from an underwater well in uncontrolled release conditions is shown, wholly indicated with reference numeral 10.

The apparatus for conveying and recovering hydrocarbons comprises a chamber 11 for the separation of a multi-phase stream consisting of the plume 23 coming from the well 20 and from sea water, into a mainly gas phase 21 and a mainly liquid phase 22, in which the mainly liquid phase 22 comprises at least one heavy phase 22a and a light phase 22b.

The separation chamber 11 comprises an inlet 11a of the multi-phase stream and a plurality of outlets 13, 14, one for conveying each of the separate phases 21, 22a, 22b, respectively.

The inlet 11a of the separation chamber 11 is advantageously made up of a directioning body 31 comprising a first end 31c for introducing the multi-phase stream and a second end that is opposite the first end, in fluid connection with the separation chamber 11.

Preferably, the second end of the directioning body ends with a perforated cap 31b.

The geometry of the perforated cap 31b is such as to dampen the amount of motion of the multi-phase stream in inlet and to help separating the gas phase 21 from the liquid phase 22.

Specifically, the directioning body 31 comprises a lower tapered portion, the wider lower end of which makes up the first inlet end 31c.

The upper narrower end of the lower portion opens out, at the top, into an upper cylindrical portion 31a of the directioning body 31, in which such an upper cylindrical portion 31a ends at the top with the perforated cap 31b.

The separation chamber 11 is placed in fluid connection with at least one collector means 12 through the outlet for conveying the light liquid phase 22b, coinciding with the inlet of at least one connection tube 14 between the separation chamber 11 and the collector means 12 having a substantially vertical arrangement.

The collector means 12 is preferably arranged at the tapered portion 31c of the directioning body 31 of the flow of hydrocarbons.

The collector means 12 has the advantageous shape such as to convey the multi-phase stream and the mainly heavy liquid phase 22a out from the separation chamber 11 towards the inlet 11a.

A preferred shape, given as a non-limiting example of the collector means 12, is the toroidal shape, which is characterised by a circular annular plan and a section that is also circular.

According to the present invention, the outlet 18 for conveying the heavy liquid phase 22a is in fluid connection with the inlet 11a of the multi-phase stream.

The outlet 18 for conveying the heavy liquid phase 22a is placed near to the first inlet end 31c of the directioning body 31.

Such an advantageous shape and arrangement of the outlet 18 for conveying the heavy liquid phase 22a promotes the recirculation of part of the plume 23 entering the separation chamber 11 and of part of the heavy liquid phase 22a separated inside such a chamber 11 and subsequently conveyed towards the inlet 11a, in such a way reducing the intake of sea water from outside.

Indeed, the difference in pressure that is generated inside the separation chamber and the inlet 11a thereof, causes the heavy liquid phase 22a to come out from the openings 18 and to re-circulate towards the jet of hydrocarbons 23, thus reducing the flow rate of water brought along with the jet towards the directioning body 31.

The outlet for conveying the gas phase is made up from a first pipeline 13 for conveying the gas phase towards the surface.

In the preferred embodiment illustrated, the separation chamber 11 is defined inside a hollow outer body 30 having a frustoconical or frusto-pyramidal shape, which is open at the bottom and connected at the top to the first pipeline 13 for conveying the gas phase towards the surface.

Preferably, the hollow outer body 30 is suitably insulated so as to keep the temperature of the single phases 21, 22a, 22b above the temperature in which hydrates are formed.

The directioning body 31, located inside the hollow outer body 30, acts as a separation element between a lower area 30a of the outer body, through which there is the introduction 11a of the multi-phase stream, and an upper area 30b of the outer body for separating the multi-phase stream, which are placed in fluid communication with one another.

In the illustrated embodiment, the cylindrical upper portion 31a of the directioning body 31 has a shorter diameter with respect to the inner diameters of the outer hollow body 30 and the lower tapered portion 31c of the directioning body 31 acts as a connection element between the lower base of the cylindrical upper portion 31a and the inner wall of the body 30.

Preferably, the directioning body 31 is arranged coaxially with respect to the hollow outer body 30, at a height that is substantially intermediate with respect to the axial extension of such a body 30.

Preferably, the tapered portion 31c has a frustoconical shape with its shorter diameter coinciding with the diameter of the cylindrical upper portion 31a and its longer diameter coinciding with a diameter of the inner wall of the outer body 30.

Inside the hollow outer body 30, it is moreover provided a hollow tubular body 32, having a circular or square-shaped section according to whether the outer body 30 has a frustoconical geometry or has the shape of a truncated pyramid, open both at the top, and at the bottom, placed at the upper area 30a of the outer body 30, therefore at the top with respect to the directioning body 31, substantially at the cylindrical upper portion 31a.

The hollow tubular body 32 is connected at the perimeter of the upper end of its side wall to the inner wall of the outer body 30.

In its side wall 32a, substantially at the upper end facing the first conveying pipeline 13, the hollow tubular body 32 is provided with at least one hole 33 that is suitable for keeping a pressure balance between the liquid arranged inside and outside the hollow tubular body 32 itself.

In the illustrated embodiment, the separation chamber 11 is delimited peripherally and externally by the inner wall of the outer body 30 and internally and below by the group made up of the directioning body 31 and the hollow tubular body 32.

In such an embodiment, the inlet 11a of the multi-phase stream is located at the lower area 30a of the hollow outer body 30 and the fluid connection with the outlet for conveying the heavy liquid phase 22a is obtained by means of a plurality of holes 18 present in the tapered portion 31c of the directioning body 31.

The collector means 12 is arranged below the tapered portion 31c of the directioning body 31 and the at least one connection tube 14 passes through such a tapered portion 31c so as to obtain the fluid connection between the collector means 12 and the separation chamber 11.

In alternative embodiments that are not illustrated, the collector means 12 is arranged at the top of the tapered portion 31c of the directioning body 31. In the case in which there are many connection tubes 14, these are preferably arranged spaced equally angularly apart along the circular development of the toroidal collector means 12.

The collector means 12 is in fluid connection with the surface by means of the interposition of pumping means 15, preferably of the type with variable revs, to which the collector means 12 is connected through a pipe 16 for conveying the light liquid phase 22b. The pumping means 15 are in turn connected to the surface through a second pipeline 17 for conveying the light liquid phase 22b.

Downstream of the pumping means 15 it is preferably provided a known type of ejection system (not illustrated), as described in WO2011/158093.

The at least one connection tube 14 has an extension inside the separation chamber 11 so that an upper end thereof 14a is positioned at a height that is greater with respect to the lower base of the cylindrical upper portion 31a of the directioning body 31 and at a height that is lower with respect to the perforated cap 31b.

In particular, the height at which the upper end 14a of the connection tube 14 is positioned, is spaced away from the height of the perforated cap 31b in a way that is sufficient so as to allow keeping the gas-liquid interface 34 at an intermediate height with respect to the height of the perforated cap 31b and to that of the upper end 14a of the connection tube 14.

The height of the gas-liquid interface 34 is, for example, adjusted by means of suitable control means (not illustrated) acting on the pressure of the system or on the number of revs of the pumping means 15 for evacuating the light liquid phase 22b.

The operation of the apparatus 10 for conveying and recovering hydrocarbons from an underwater well for extracting hydrocarbons in uncontrolled release conditions is as follows.

In the operative condition the plume 23, consisting of a mixture of gas and oil, comes out at high pressure from the well 20, in such a way incorporating inside it sea water, and is intercepted, at a certain height, by the apparatus 10 for conveying and recovering hydrocarbons according to the invention, wherein the height is determined by the operative conditions of the apparatus 10.

The sea water entering inside the apparatus for conveying and recovering hydrocarbons 10 forms the heavy liquid phase 22a.

The multi-phase stream in inlet, thus consisting of at least oil, gas and sea water, enters inside the separation chamber 11 of the apparatus for conveying and recovering hydrocarbons 10 through the directioning body 31.

The geometry of the directioning body 31, together with that of the perforated cap 31b is such as to dampen the amount of motion of the stream in inlet.

The amount of the damping carried out by the perforated cap 31b depends upon the height at which the flow of the multi-phase stream in outlet from the well is intercepted.

Passing through the holes of the perforated cap 31b the multi-phase stream enters inside the separation chamber 11 where the oil-gas-water mixture tends to separate and to be stratified in three phases.

By gravity, there is a first separation into a mainly gas phase 21 consisting of a mixture of gas and liquid hydrocarbons, and a mainly liquid phase 22, consisting of a mixture of water and liquid hydrocarbons containing small amounts of dispersed gas.

Moreover, the mainly liquid phase 22 stratifies at the top into a light hydrocarbon phase 22b and at the bottom into a heavy liquid phase 22a mainly consisting of water.

The gas phase 21 flows towards the first pipeline 13 for conveying the gas phase towards the surface.

The light hydrocarbon phase 22b flows, through the at least one connection tube 14, into the collector means 12 from which it is subsequently sucked by the pumping means 15 and conveyed to the surface inside the corresponding second pipeline 17 for conveying the light liquid phase 22b towards the surface.

In the case in which there is an ejection system, the pumping means 15 convey the light liquid phase 22b through it.

The heavy aqueous phase 22a stratified in the lower part of the separation chamber 11, is roughly separated and flows through the holes 18 present in the tapered portion 31c of the directioning body 31 towards the inlet 11a of the separation chamber.

At the inlet 11a of the separation chamber, by exploiting the pressure gradients present inside the separation chamber 11, the stream of roughly separated aqueous phase 22a rotates around the collector means 12 and is recirculated with the plume 23.

The characteristics of the device object of the present invention are clear from the description made, just as the relative advantages are also clear.

The incorporation of the stream of roughly separated aqueous phase with the plume coming out from the well minimises the dilution of the multi-phase stream entering the separation chamber.

Analogously, also the part of plume which does not enter inside the separation chamber is recirculated with the plume in outlet from the well, possibly rotating around the collector means, avoiding also in this case the incorporation of sea water from outside and consequently a dilution of the multi-phase stream entering the separation chamber.

This leads to a considerable reduction of the requirement of surface separation treatments.

Moreover, the recirculation of part of the plume and of the roughly separated aqueous phase, considerably reducing the incorporation of sea water from outside, having temperatures that are substantially lower, leads to an overall increase in the temperature of the multi-phase stream entering the apparatus.

By maintaining the temperature of the plume, also promoted by the insulation of the outer wall of the separation chamber, the risk of hydrates forming is considerably reduced.

It is finally clear that the device thus conceived can undergo numerous modifications and variants, all covered by the invention; moreover, all the details can be replaced by technically equivalent elements. In practice the materials used, as well as the dimensions, can be any according to the technical requirements.

1. An apparatus for conveying and recovering a flow of hydrocarbons from an underwater well or pipe line under blowout condition comprising a separation chamber having an inlet for a multiphase stream comprising said flow of hydrocarbons exiting from said well or pipe line, and a plurality of outlets for respectively conveying a prevalently gaseous phase, a prevalently light liquid phase and a prevalently heavy liquid phase deriving from the separation of said multiphase stream at the inlet, said inlet comprising a directioning body of said multiphase stream towards the interior of said separation chamber, said directioning body comprising a first inlet end of said multiphase stream and a second end opposite to said first end, said second end being in fluid connection with said separation chamber, wherein an outlet for said prevalently heavy liquid phase of said plurality of outlets is in fluid connection with said inlet of said separation chamber.

2. The apparatus for conveying and recovering a flow of hydrocarbons from an underwater well or pipe line under blowout condition according to claim 1, wherein said outlet for said prevalently heavy liquid phase is situated near said first inlet end of said directioning body.

3. The apparatus for conveying and recovering a flow of hydrocarbons from an underwater well or pipe line under blowout condition according to claim 1, wherein said directioning body comprises a first lower portion having a tapered shape, whose largest end forms said first inlet end, said outlet for said prevalently heavy liquid phase being obtained in said lower portion having a tapered end of said directioning body.

4. The apparatus for conveying and recovering a flow of hydrocarbons from an underwater well or pipe line under blowout condition according to claim 1, wherein said outlet for said prevalently heavy liquid phase comprises a plurality of holes.

5. The apparatus for conveying and recovering a flow of hydrocarbons from an underwater well or pipe line under blowout condition according to claim 4, which additionally comprises at least one collector means in fluid connection with an outlet for said prevalently light liquid phase of said plurality of outlets, said collector means being situated at said inlet of said separation chamber and having such a shape as to convey, towards said inlet, said multiphase flow and said prevalently heavy liquid phase exiting from said separation chamber through said plurality of holes.

6. The apparatus for conveying and recovering a flow of hydrocarbons from an underwater well or pipe line under blowout condition according to claim 5, wherein said collector means has a toroidal shape.

7. The apparatus for conveying and recovering a flow of hydrocarbons from an underwater well or pipe line under blowout condition according to claim 1, wherein an outlet for said prevalently gaseous phase of said plurality of outlets comprises a first conveying duct towards the surface and wherein said separation chamber is defined inside an outer hollow body having a frustoconical or frusto-pyramidal shape, open below and connected above to said first conveyance duct to the surface.

8. The apparatus for conveying and recovering a flow of hydrocarbons from an underwater well or pipe line under blowout condition according to claim 7, wherein said outer hollow body is thermally insulated.

9. The apparatus for conveying and recovering a flow of hydrocarbons from an underwater well under blowout condition according to claim 3, wherein the narrowest end of said first lower portion having a tapered shape of said directioning body leads from above into an upper cylindrical portion, said upper cylindrical portion terminating above with a perforated cap forming said second end of said directioning body.

10. The apparatus for conveying and recovering a flow of hydrocarbons from an underwater well or pipe line under blowout condition according to claim 9, wherein said directioning body is positioned inside said hollow body, coaxially, said upper cylindrical portion having a smaller diameter with respect to the internal diameters of said outer hollow body and said lower tapered portion having a frustoconical shape with a smaller diameter, coinciding with the diameter of said upper cylindrical portion and a larger diameter coinciding with a diameter of the internal wall of said hollow body, thus acting as a connection between the lower base of said upper cylindrical portion and the internal wall of said hollow body.

11. The apparatus for conveying and recovering a flow of hydrocarbons from an underwater well or pipe line under blowout condition according to claim 10, wherein, inside said hollow body, there is a hollow tubular body open is present above and below, and situated substantially at said upper cylindrical portion of said directioning body.

12. The apparatus for conveying and recovering a flow of hydrocarbons from an underwater well or pipe line under blowout condition according to claim 11, wherein, in its side wall, said hollow tubular body has at least one hole.

13. The apparatus for conveying and recovering a flow of hydrocarbons from an underwater well or pipe line under blowout condition according to claim 5, wherein said outlet for said prevalently light liquid phase comprises at least one duct in a substantially vertical connection position between said separation chamber and said collector means.

14. The apparatus for conveying and recovering a flow of hydrocarbons from an underwater well or pipe line under blowout condition according to claim 13, wherein said collector means is situated below said tapered lower portion of said directioning body, said at least one connection duct passing through said tapered lower portion so as to form said fluid connection between said collector means and said separation chamber.

15. The apparatus for conveying and recovering a flow of hydrocarbons from an underwater well or pipe line under blowout condition according to claim 13, wherein said at least one connection duct has an extension inside said separation chamber so that one of its upper ends is positioned at an upper height with respect to the lower base of said upper cylindrical portion of said directioning body and at a lower height with respect to said perforated.

16. A process for conveying and recovering a flow of hydrocarbons from an underwater well or pipe line under blowout condition comprising:
intercepting a multiphase stream comprising said flow of hydrocarbons exiting from said well or pipe line, and conveying the multiphase stream to an inlet of a separation chamber;
separating said entering multiphase stream into a prevalently gaseous phase, a prevalently light liquid phase and a prevalently heavy liquid phase;
conveying said prevalently gaseous phase, said prevalently light liquid phase and said prevalently heavy liquid phase each respectively through an outlet of a plurality of outlets;
reconveying said prevalently heavy liquid phase exiting from said separation chamber towards said inlet, and recirculating said prevalently heavy liquid phase with said multiphase stream entering said separation chamber.

17. The process for conveying and recovering a flow of hydrocarbons from an underwater well or pipe line under blowout condition according to claim 16, wherein said reconveying of said prevalently heavy liquid phase exiting from said separation chamber towards said inlet comprises rotating said prevalently heavy liquid phase around a collector means to recirculate said prevalently heavy liquid phase with said multiphase stream entering said separation chamber.

18. The process for conveying and recovering a flow of hydrocarbons from an underwater well or pipe line under blowout condition according to claim 16, it which additionally comprises damping momentum of said multiphase stream entering said separation chamber.
